(19) United States
(12) Patent Application Publication
(10) Pub. No.: US 2008/0077487 A1
(43) Pub. Date: Mar. 27, 2008

(54) Targeted Incentives Based Upon Predicted Behavior

(76) Inventors: Mark Davis, Clearwater, FL (US); Patrick Venker, Oldmar, FL (US)

Correspondence Address: NEIFELD IP LAW, PC, 4813-B EISENHOWER AVENUE, ALEXANDRIA, VA, 22304, US

(21) Appl. No.: 11/554,663

(22) Filed: Oct. 31, 2006

Related U.S. Application Data
(60) Provisional application No. 60/826,497, filed on Sep. 21, 2006.

(51) Int. Cl. G06Q 30/00

(52) U.S. Cl. 705/14

(57) ABSTRACT

A computer implemented system and method employs predictive analysis on purchase data to determine product categories for which a consumer is statistically likely to purchase and either has not purchased or has not purchased at the statistically expected level at a particular retail store or chain of retail stores, and responds by generating a purchase incentive offer for that consumer requiring purchase of a product in the target category as a condition for the consumer obtaining the offered incentive.

### CROSS REFERENCE TO RELATED APPLICATIONS

### Priority Data

This application claims priority to U.S. provisional application 60/826,497, filed Sep. 21, 2006, attorney docket number PIP192DAVIP-US, titled “Improved Targeted Incentives Based Upon Predicted Behavior”.

### BACKGROUND OF THE INVENTION

1. Field of the Invention

The invention relates to the field of marketing. More particularly, the invention relates to targeted marketing.

2. Discussion of the Background

Acronyms

CID is an acronym for Consumer IDentification.

CS is an acronym for Computer System.

PID is an acronym for Product IDentification, such as a UPC code.

TID is an acronym for Transaction IDentification.

Definitions

Targeted marketing means selectively marketing to a limited number of consumers, such as an individual, members of a family, persons with the same residence as one another, or persons having some other piece of relevant information in common with one another. U.S. Pat. No. 5,832,457 to O'Brien discloses targeted marketing.

Predictive modeling in this application means using data corresponding to prior events to determine a probability of occurrence of an event during the prior event time period or during some subsequent time period. An example of a predictive model would be a formula whose inputs are the number of sun spots recorded over each of the last several years and whose output was a probability of a number of sunspots during the next year falling within a specified range. Predictive modeling is disclosed in U.S. Pat. No. 4,961,089 to Jamzadeh.

Transaction, in this application, means an exchange involving at least two parties. A purchase is a transaction. Receipt of an incentive offer (such as the act of downloading an incentive offer from a web site), redemption of an incentive offer, and acceptance of participation in a consumer survey are transactions.

Purchase, in this application, means a transaction in which cash, check, charge, or credit is exchanged for one or more products and services.

Purchase incentive offer, in this application, means an incentive contingent upon a specified purchase.

Purchase history means identification of a consumer (CID) in association with identification of product items purchased by the consumer, and also optionally and preferably date of purchase, quantity of items of each product, price per product item, and other information about the consumer's purchases. Purchase history data means data storing purchase history information. Purchase history records refer to records for each consumer or household in which this type of information is stored in association with the consumer's or household's identification or identifications.

Product herein means products and services available for purchase from a retail store.

Category herein means a set of things that share a common attribute. The words class and category are used interchangeable herein.

In this application, the term database means data organized in some format in a computer memory that can be accessed by an associated CS. Such a concept is also referred to as a database management system. A database or database management system includes commercial database products implemented in a CS, such as the Microsoft Access and SQL Server line of products as well as any set of files stored in computer memory that can be accessed by an associated CS.

Data defining a good or a service may be stored in a database.

### DISCLOSURE OF THE INVENTION

### Objects of the Invention

It is an object of the invention to increase volume of purchases in a retail store.

It is an object of the invention to incent a consumer to purchase products in a retail store from a product category that the consumer does not normally purchase in that retail store but from which product category the consumer is likely to purchase.

### SUMMARY OF THE INVENTION

The invention provides predictive modeling of product purchase history data to predict the likelihood and optionally the quantity of purchase by a consumer in a product category, to determine, for product purchase history data for the customer's purchases in a particular retail store or chain of retail stores, those consumers having either zero or less than the predicted amount of purchase in that product category, and to target market to those consumers in that retail store, products in that product category.

These and other objects are provided by a computerized system and method that generate decisions whether to offer consumers transaction incentives for purchase of products by:

(1) determining from purchase history records for consumers for purchases in one or more retail stores that occurred during a specified time period, first target category non purchase CIDs whose purchase history records show no purchase in a first target category;

(2) applying to purchase histories of said first target category non purchase CIDs, a first target category correlation function, wherein said first target category correlation function correlates likelihood that a CID is associated with purchases in said first target product category, to obtain in association with each one of said first target category non purchase CIDs of first target category correlation values;

(3) generating a first target category incentive offer set of CIDs by selecting from said first target category non purchase CIDs a predetermined number or fraction of CIDs having the highest first target category correlation values;

(4) associating data representing a purchase incentive offer requiring purchase of at least one product item in said first target category, with at least a first CID of said first target category incentive offer set of CIDs.

These objects are also achieved by applying the foregoing methodology to a set of target categories, to determine products that a consumer associated with a first CID is likely to purchase and has not purchased in the one or more retail stores, and associating with the first CID one or more purchase incentive offers for that consumer, each purchase incentive offer for contingent upon purchase of one or more products in said set of target categories.

In one alternative, the foregoing methodology is applied to a set of categories for a first CID, to determine plural categories in which the corresponding consumer is likely to purchase but has not purchases from the one or more retail stores, and associating data defining a combination purchase incentive offer with the CID. The combination purchase offer would include terms requiring purchase by the consumer of plural items from plural categories from which the consumer is likely to purchase but has not purchased from the one or more retail stores, and provide a reward, typically a dollar amount, for purchasing all of those products. Generally, the amount of the reward would be larger than an amount for a purchase incentive offer requiring purchase of only a single product item.

The objects are also achieved by applying the foregoing methodology to associate such purchase incentive offers with multiple CIDs corresponding to multiple consumers.

The target category correlation function for each target category is obtained using predictive modeling analysis applied to the purchase history of a set of consumers for a defined time period. The predictive analysis determines correlations between purchases of products in other than the target category that correlate to either concurrent or subsequent in time purchase in the target category.

For example, the correlation function may be a linear equation consisting of a sum of terms, wherein each term is a coefficient multiplied by variable defining product or category purchase volume (number of product items purchased or currency value of product items purchased), for a set of categories. Each coefficient may represent the value of correlation of purchase of products in a non target category (during a first time period) to purchase of products in the target category (during the first time period or during a subsequent second time period). Each coefficient multiplied by a numerical value indicative of the consumer's purchase volume (based upon price, quantity), and recency of purchase (based upon date of purchase and current date) in each non target category contributes to a measure of likelihood that the consumer purchases in the target category. A sum of terms of such a correlation function is indicative of the likelihood that the consumer purchases in the target category.

The numerical value indicative of the consumer's purchase volume (based upon price, quantity), and recency of purchase (based upon date of purchase and current date) may be a price, quantity, or a function of either of both, such as quantity times price or quantity plus price. In addition, the numerical value may also be a function of the date of purchase and current date. For example, quantity times price divided by the difference between current date and date of purchase. For example, quantity divided by the difference between current date and date of purchase. For example, price divided by the difference between current date and date of purchase. For example, quantity plus price divided by the difference between current date and date of purchase. One purpose of including time in the function is to discount the correlation to older in time purchases.

An example of such a target category correlation function involving four product categories is:

CF1=a12*P2+a13*P3+a14*P4 (1)

where CF1 is the correlation function for purchase in category 1 and a12 is the coefficient for purchase from category 2, P2 is a variable measuring the volume of purchase in category 2, a13 is the coefficient for purchase from category 3, P3 is a variable measuring the volume of purchase in category 3, and a14 is the coefficient for purchase from category 4, P4 is a variable measuring the volume of purchase in category 4, and the asterisk sign indicates multiplication. This function would be applied to a CID purchase history, such as CID1, for a specified time period, such as (4,0,1) resulting in CF1(CID1)=a12*4+a13*0+a14*1. For example, if a12=1, a13=0.5 and a14=1, then CF1(CID1)=4+0+1=5.

Such a function however is not normalized, in the sense that it's resulting value is not a measure of probability (from zero to one) of purchase of a volume or quantity of product in the target category, and does not indicate an expected amount of product purchases in a target category. However, such a function can be normalized by normalizing the values of the coefficients. For example, by scaling the values of the coefficients so that the amounts of actual purchases in the target category based upon the actual numbers of purchases in the target category associated with the CIDs from which the correlation function is derived equals the sum of the values of the correlation function applied to that set of CIDs. This defines a normalized target correlation function. The value of the normalized correlation function varies from CID to CID, since the function's value depends upon product purchases associated with each CID. In the foregoing example, assuming the normalization weighting function scaled the coefficients to 0.1 of their original values, then the not normalized coefficient values of a12=1, a13=0.5 and a14=1 would be normalized to values of a12=0.1, a13=0.05 and a14=0.1. In the same example, the not normalized correlation function of CF1(CID1)=a12*4+a13*0 +a14*1 would be normalized to CF1(CID1)=0.1*4+0.05*0+0.1*1=0.5.

In one alternative, a first CID's purchase history is applied to a normalized target category correlation function to provide a value of that function for that CID. That value is compared to actual purchase quantity or volume for the first CID. If the actual purchase quantity or volume for the first CID is less than a specified fraction of a value of the normalized target correlation function, such as less than 0.1, 0.2, or 0.5 of the value of the normalized correlation function for the first CID, the system associates data defining a purchase incentive offer for that target category with the first CID. As with the prior embodiment, in this alternative, the system may determine combination incentive offers for the first CID.

In another alternative, the system stores a base value of a product incentive offer and scales or depends the base value for a first CID based upon a difference between the value of the a normalized target category correlation function for the first CID and the value for quantity or volume of purchases in the target category associated with the first CID. For example, a CID having no purchases in the target category and a high value for the target category correlation function may be associated with a purchase incentive offer for purchase of a product in the target category that has a relatively large reward value; a CID having substantial purchases in the target category and a high value for the target category correlation function may be associated with a purchase incentive offer for purchase of a product in the target category that has a relatively small reward value; and a CID having purchases in the target category that exceed the value for the target category correlation function may be associated with no purchase incentive offer for purchase of a product in the target category.

Customer store loyalty quotient data is data indicating the fraction of a customer's expenses in each category that the consumer purchases in that particular store. This data is derived from comparison of block data for category purchases (which are average values for a small geographic or residence address region) to actual category household purchase data for the consumer or the consumer's household obtained from the retail store. Block data is not based upon predictive analysis, but instead, based upon, demographic statistics for a region.

### ASPECTS OF THE INVENTION

In one aspect, the invention provides a computerized method and system for selecting consumers to which to provide purchase incentive offers for purchase of products, comprising: storing in computer memory purchase history data for purchases from one or more retail stores during a certain time period, wherein said purchase history data includes CID records, wherein each CID record stores in association with one another at least CID, PIDs of products purchased in transactions associated with said at least one CID, and quantity of product items having said PIDs; defining a Target Category Correlation Function (TCCF) for a target category, wherein said TCCF is a function of at least quantity of purchase of products in non target categories; applying statistical analysis to at least a subset of said purchase history records and said TCCF to define values of coefficients for terms of said TCCF, said values corresponding to correlation of purchase of products in non target categories to purchase of products in said target category; applying said TCCF to purchase history records associated with CIDs to obtain CID TCCF values for said CIDs; deciding whether to provide purchase incentive offers for purchase of products in said target category to consumers associated with said CIDs based at least in part upon said CID TCCF values.

Additional dependent aspects are: wherein said (5) deciding is also based at least in part upon values for quantity or volume of purchase in said target category associated with said CIDs; wherein said (1) storing also comprises storing in said CID records volume of product items having said PIDs; wherein said (5) deciding further comprises: determining from said CIDs target category offer CIDs (i) whose purchase history records have no purchases in said target category and (ii) that have relatively high TCCF values; and associating with at least one of said target category offer CIDs purchase incentive offer data identifying at least one product in said target category; wherein said TCCF is normalized so that its value defines an expected volume of purchase in said target category, wherein volume is a measure of at least one of number of product items purchased and currency value of product items purchased; and further comprising determining a ratio of actual purchase volume in said target category to CID TCCF value for one of said CIDs; wherein said purchase history data includes a plurality of CID records for a CID, wherein each one of said plurality of CID records storing data corresponding to a single transaction; wherein said purchase history data includes a plurality of CID records for a CID including at least one record storing data from more than one transaction; wherein said purchase history data includes a plurality of CID records for a certain CID, each of said plurality of CID records storing transaction data for transactions in a time period, such that different ones of said plurality of CID records store transaction data from different time periods; wherein said TCCF has the form of a linear equation consisting of a sum of terms, wherein each term is a coefficient multiplied by a variable indicating product or category purchase volume; wherein said coefficient is a measure of statistical correlation of purchase in a non target category to purchase in said target category; wherein said TCCF has the form of a sum of terms Aij*Pj where Aij represents statistical correlation of purchase in an ith non target category to purchase in target category j, and Pj is a variable representing the volume of purchase in category j; wherein said relatively high TCCF values including only values within the top 20 percent of all TCCF values; wherein said determining a ratio comprises determining whether said ratio is less than a specified fraction which is less than one; further comprising defining TCCFs for a plurality of categories, and performing (3) to (5) for each one of those TCCFs; wherein at least one of said purchase incentive offers defined a plurality of products, each one of said plurality of products in a different category, and said purchase incentive offer required a consumer to purchase each one of said plurality of products in order to receive an incentive associated with said at least one of said purchase incentive offers; further comprising transmitting said purchase history data to a central CS and wherein steps (1) occurs at said central CS; wherein steps (3) and (4) occur at said central CS; further comprising transmitting a subset of said CIDs and associated product purchase incentive offers for said target category from a central CS to a POS CS from which transaction data containing CIDs in said subset had been transmitted to said central CS; further comprising associating all CIDs records associated with the same residence address with a single CID; and further comprising limiting determining said subset of said purchase history records by selecting from said purchase history records only those records in which block data and retail store customer data from a retail store indicate that all purchasers from the same residence address purchase in said retail store.

In one system aspect, the invention a computer system for selecting consumers to which to provide purchase incentive offers for purchase of products, comprising at least one central processing unit; an input device; an output device; and computer memory and code for storing data and codes specified in (1)-(5). Dependent features of this aspect include: wherein element (1) is stored in a central CS and element (2) is not stored on said central CS; and wherein elements (1), (4), and (5) are stored in a central CS.

### BRIEF DESCRIPTION OF THE FIGURES

The invention is better illustrated in connection with the following figures.

FIG. 1 is a schematic of a novel network CS 1;

FIG. 2 is a schematic of a novel retailer POS CS 50;

FIG. 3 is a flow chart of a novel method of providing product purchase incentive offers to customers; and

FIG. 4 is a set of design views of novel data structures.

### DETAILED DESCRIPTION OF THE PREFERRED EMBODIMENTS

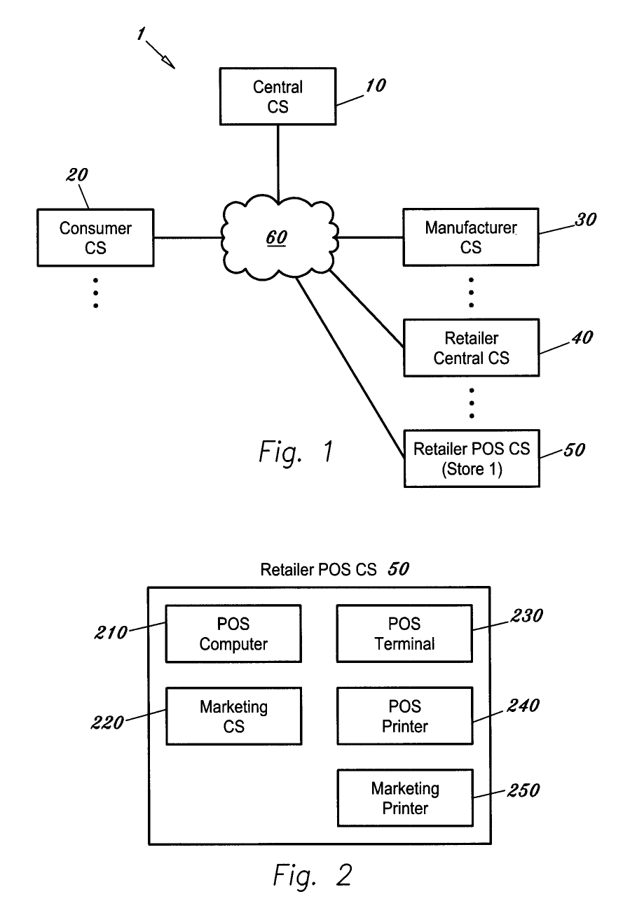

FIG. 1 shows network CS 1 including central CS 10, consumer CS 20, manufacturer CS 30, retailer central CS 40, retailer POS CS 50, and Network 60. The ellipses below elements 20-25 indicate that plural such elements exists.

Each CS disclosed herein includes a central processor, memory, and structure for input and output of data. Each CS also includes operating system code enabling the CS to run utility and applications software.

Network 60 preferably is the Internet. It enables two way packet communication preferably via TCP/IP between remotely located CSs.

FIG. 2 shows an embodiment of retailer POS CS 50 including POS computer 210, marketing CS 220, POS terminal 230, POS printer 240, and marketing printer 250. Marketing CS 220 and marketing printer 250 are optional, as essential functions of these elements can be incorporated into POS computer 210 and POS printer 240. Preferably, each POS has a POS terminal, a POS printer, and a marketing printer nearby.

The elements of POS CS 50 may be configured to interact with one another in various ways. For example, elements 21-25 may all interact via a LAN. Alternatively, POS terminals and/or printers may be dumb terminal devices controlled by POS computer 210.

In one embodiment, POS computer 210 and POS terminals 230 form a LAN, and each POS printer is controlled by a corresponding POS terminal. In this embodiment, marketing CS 220 and marketing printer(s) 250 form a second LAN, and marketing CS 220 transmits print instructions to marketing printer(s) 250. Marketing CS also has structure for receiving data signals on the LAN that includes POS computer 210. From these signals, marketing CS 220 obtains and logs transaction data for transactions occurring in the retail store. In addition, CS 220 determines CIDs read at a POS and the corresponding POS terminal identifications where the CIDs are read. CS 220 triggers printing of data defining incentive offers associated with the CID stored in memory of the marketing CS 220, at the marketing printer 250 at the corresponding POS. Additional triggering of printing may be based upon PID instead of CID.

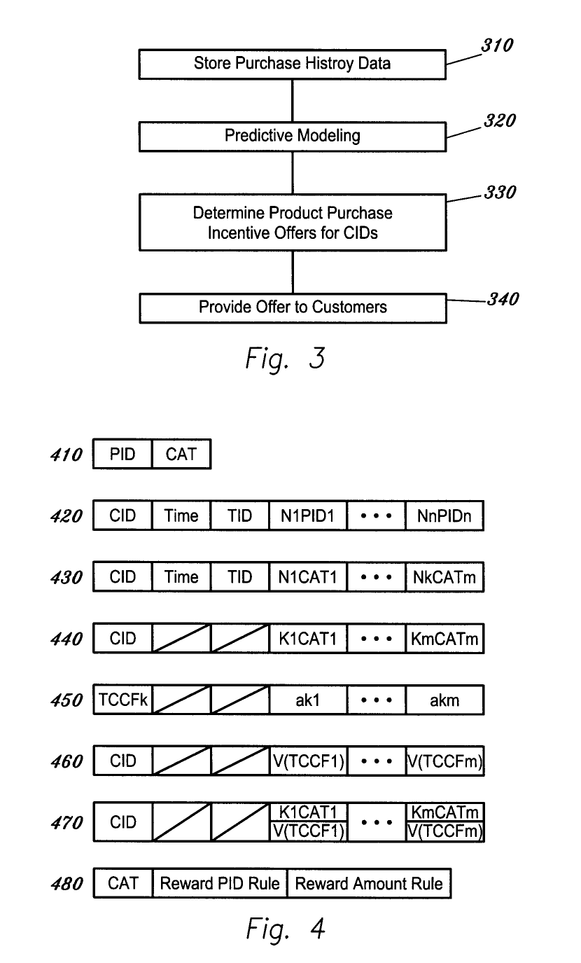

FIG. 3 shows an overview of a method of operation without reference to where the steps occur in network 1 and without reference to details of each step.

In step 310, network CS 1 stores purchase history data.

In step 320, network CS 1 implements predictive modeling on stored purchase history data.

In step 330, network CS 1 determines product purchase incentive offers for CIDs.

In step 340, network CS 1 implements processing to provide the product purchase incentive offers to consumers associated with the CIDs.

Step 1 may include the receipt in retailer POS CS 50 of a retail store of transaction data for transactions of consumers in the retail store. Step 1 may also include transmission from the retail store of transaction data for consumers' purchases in that store to another CS, such as central CS 10. The transaction data information may be initially locally stored. The transaction data information may then be transmitted either from marketing CS 220 or POS computer 210 directly (via the Internet or a private network) to central CS 10 or from marketing CS 220 through POS computer 210 and then to central CS 10. Each information transmission to central CS 10 may consist of a single transaction record, or it may consist of many transaction records, such as all transaction records occurring during one business day in the retail store.

The purchase history data is a compilation of transaction data for transactions from multiple consumers over a period of time.

The purchase history data preferably includes in association with a CID, transaction date, and associated with each transaction date: PIDs of products and quantity of products purchased on each date; cost of items purchase, redemptions of incentive offers and quantity of redemptions of each incentive offer; redemption amounts; payment method (cash, check, credit card); and amount of transaction. Many other transaction data variables may be stored.

In step 320, network CS 1 implements predictive modeling on stored purchase history data. The modeling may be implemented using any CS in network CS 1. In one embodiment, modeling is implemented in central CS 1. In another embodiment, modeling is implemented in marketing CS 220 of retail POS CS 50. Alternatively, modeling may be implemented by retailer or manufacture central CSs 30, 40, or POS CS 210.

In one preferred embodiment relating to predictive modeling, each PID is heuristically associated with a product category. For example, all products identified as coffee (coffee grinds and decaffeinated coffee crystals) may be associated with a coffee category. In another embodiment, which is not based upon heuristic correspondence of products to categories, each PID is modeled as a distinct product category.

In the heuristic embodiment, the following represents the currently specified list of product categories: Baby Food; Baking Mixes; Baking Needs; Candy; Cereal RTE; Cocoa Mix & Milk Modifiers; Adult Nutritional Drinks & Bars; Coffee—Instant/RTS; Gravies & Sauces; Cookies; Crackers; Croutons/Bread Crumbs; Desserts/Toppings; Artificial Sweetners; Fish, Canned; Flour; Fruit, Canned; Fruit, Dried; Gum; Household Cleaning Compounds; Household Cleaning Supplies; Jams/Jellies/Spreads/Other Sweets; Juice/Juice Drinks—Shelf Stable; Laundry Supplies; Pasta—Dry; Meat, Canned; Milk, Canned & Powdered, S/S; Paper Products—General; Disposable Baby Diapers; Bath Tissue; Dog Food; Pickles & Relishes; Prepared Foods—Dry; Salad Dressings/Toppings; Salt, Seasonings & Spices; Shortening & Oils; Snacks; Soaps—Bar & Liquid; Dishwashing Detergents; Soft Drinks Non Cola & Mixes; Water/Tang; Soup; Sugar; Tea; Vegetables, Canned & Dried; Eye/Nose/Foot Care; Frozen Baked Goods; Frozen Chicken/Poultry; Frozen Juice & Drinks; Frozen Potatoes/Onion Rings; Frozen Prepared Food & Pot Pies; Frozen Vegetables; Frozen Breakfast Food; Frozen Novelties; Cheese; Yogurt; Lunch Meats; Margarine; Refrigerated Cookies & Rolls; Refrigerated Salads; Misc. Refrigerated Foods; Beer (Alcoholic & Non Alcoholic); Pie Shells; Baby Needs; Deodorants; First Aid; Hair Care Needs; Oral Hygiene; Proprietary Remedies; Toothpaste; Shaving Needs; Skin Care Aids; Hosiery; Magazines, Books & Records; Tobacco (ex Cigarettes); Service Deli; Distilled Spirits; Beauty Aids; Greeting Cards; Coupon Redemptions; Cigarettes; Fresh Fruit (Non PLU); Fresh Vegetables (Non PLU); Contraceptives; Pregnancy Test Kits; Film/FilmProcessing; Refrigerated Juices; Milk; Bagels/Toaster Pastries/Tarts; Feminine Hygiene; Pediatrics/Nutritional Bars/Water; Cereal/Granola Bars; Incontinence Pads; Frozen/Refrigerated Pizza; Laundry Detergents; Coffee—Ground; Fruit Snacks; Snack Cakes; Air Freshener/Carpet Deodorizers; Coffee Creamers—Shelf Stable; Food Storage; Dog Snacks, Chews; Lunch Combinations; Rice; Pet Supplies/Litter; Trash Bags; Fresh Fish/Seafood; Frozen Fish/Seafood; Frozen Meats; Refrigerated Meats; Refrigerated Poultry; Bread/Rolls—Fresh; Energy Drinks; Sports Drinks; Moist Towelettes; Sour Cream Regular & Low Fat; Vitamins/Minerals; Frankfurters; Paper Towels; Paper Napkins; Facial Tissue; Condiments; Fabric Softeners; Peanut Butter; Veg Juice—Shelf Stable; Cat Food; Cat Snacks; Soft Drinks—Cola; Syrups & Molasses; Butter; Bacon; Bakery; Household Supplies—Misc; Cereal—Hot; Desserts—Refrigerated; Meat Substitutes—Frozen/Refrigerated; Pasta—Frozen/Refrigerated/Canned; Coffee Creamers—Refrigerated/Frozen; Prepared Salads (Non PLU); Ice Cream; Wine; Prepared Foods—Ready to Serve; Eggs; Stationery/Giftwrap/School Supplies; Cocktail Mixes Non—Carbonated; Sausage/Ham; Paper Products—Misc.; and Snack Nuts.

The generation of the predictive modeling functions for each product category preferably includes the following steps: storing in central CS 10 associations of each of the PIDs to one of the product categories; receipt by central CS 10 of purchase history data from a plurality of retail POS CSs 50 corresponding to a plurality of retail stores; and selecting a subset of that purchase history data for predictive modeling.

Predictive modeling per se is not novel. However, it is novel as used herein. Predictive modeling is applied to the subset of that purchase history data to determine the correlations of purchase of product in each target category to purchase in one or more other categories, preferably at least 5 other categories, more preferably at least other 20 categories, and most preferably all categories other associated with PIDs.

The predictive model example noted above applied a set of linear equations and category correlation coefficients in which each coefficient was based upon correlation of purchase in the target category to purchase in one other category. However, the concept disclosed herein is not limited to any particular correlation model. Thus, for example, the correlation model may employ correlation terms relating purchase in the target category to a sum of purchases in more than one other category, higher order correlation coefficients, etc. One tool for implementing predictive modeling is the software program for statistical analysis, named SAS. Code for implementing this type of analysis in SAS is contained in attachments I-V at the end of this specification.

Attachment I, Likely_BUYERS, generally performs the functions of creating a dataset containing 50,000 records comprised of ⅓ buyers of the target category and ⅔ nonbuyers of the target category, then runs the following programs in this order: VarSelLogReg, BestVars, ScoreLogReg, EvalScore, and does this in a loop for all 150 LQ categories, at the end collecting all of the evaluation results into one report.

Attachment II, Evalscore, generally performs the functions of evaluating the performance of the multiple linear model created by scorelogreg against the holdout dataset set aside in scorelogreg.

Attachment III, ScoreLogReg, generally performs the functions of using SAS′ proc logistic function to create a multiple regression model on the target category using the 50 variables selected by varsellogreg. ⅔ of the data are used to train the model, the other ⅓ is set aside for EvalScore.

Attachment IV, BestVars, generally performs the functions of selecting the top 50 variables from the output dataset of varsellogreg and creates a dataset that is a subset of the original modeling dataset in step I with only the top 50 variables plus the target category purchase variable.

Attachment V, Varsellogreg, generally performs the functions of SAS Logistic Regression method of selecting variables using backward, Fast settings, which use brand and bound techniques to select the highest correlated measures with the target category and ranks them by their p values.

In step 340, CS1 implements steps to provide product purchase incentive offers to consumers. This includes for example the sub steps of associating in central CS 10 product purchase incentive offers for products in the target category with CIDs identified in the predictive analysis for that target category, transmitting the identified CIDs and data defining the product purchase incentive offers to the retailer store POS CS 50 from which the identified CIDs were originally received by central CS 10, identifying in retail store POS CS 50 an identified CID in a transaction in the retail store, and, while the consumer associated with the CID is likely to still be at the POS, responding to the identification by printing the product purchase incentive offers defined by the data defining the product purchase incentive offers on marketing printer 250 (or POS printer 240).

Alternatively, central CS 10 may generate instructions for postal mailing the product purchase incentive offers to a postal address associated with the identified CIDs. The postal mailing instructions would preferably be implemented by a fulfillment mailing company. Thus, central CS 10 would email or make available for download the postal information to the fulfillment company, and the fulfillment company would print and mail.

Alternatively, central CS 10 may generate instructions for e-mailing the product purchase incentive offers to an email address associated with the CID. Central CS10 or another CS may then implement e-mailing the product purchase incentive offers to the corresponding email addresses.

Alternatively, central CS 10 may generate instructions for a web server to respond to receipt of data identifying the CID (consumer) and responding by transmitting either a web page (to the address of the requesting computer) or an email (to an email address associated with the CID) containing the product purchase incentive offers for that CID.

FIG. 4 shows exemplary design views of novel data structures useful in the process of the invention.

410 shows a table associating fields for PIDs (product identifications) with fields for CATs (product categories). Preferably, there are several products associated with each category. Each datum in each PID field is unique (only appears once) in records in this table. The data in the CAT fields of the records is not unique; it may repeat. This table is useful to assign a CAT to each PID.

420 shows a table for transaction data, associating data elements of a transaction with one another in the same record. The data elements are CID, time, TID, NaPID1 . . . NnPIDn. Here, N1PID1 represents the quantity of purchase of product having product identifier PID1. The ellipses represent a series of such terms for each PID, ending in PIDn. Thus, NnPIDn represents the quantity of PIDn items in the purchase transaction.

430 shows a table for transaction data similar to 420. However, 430 associates with the transaction, quantity of purchases by category (CATs) instead of by product identifier, PID. In implementation, code reads data in tables 410 and 420, sums to NiCATi the quantity of purchases of all items in CATi, to derive the values for NiCATi for that transaction record for CATs 1, . . . m. Typically, there are thousands of PIDs (1 . . . n) and much fewer CATs (1 . . . m). Therefore, the N1 . . . Nm values in table 430 should generally be larger than the N1 . . . Nn values in table 420.

440 shows a table for transactions by CID summed by category and period of time. Several transactions for a CID may exist in the specified time period table 430. The quantity values for those transactions for each category appear as a sum in table 440. The coefficients KiCATi (i= . . . m) represent the sum of the corresponding N1 from table 430 having the same CID and in the specified time period. The data in table 440 is useful for predictive analysis modeling. This is because the purchase history data is preferably in this form (integrated over category and time period) when used as input for predictive modeling disclosed herein. Of course, there may be several time periods each of which corresponds to a record for the same CID in table 440. That is, the predictive model used may include modeling of patterns over time to determine likelihood or expectation value of purchase by a consumer of products in a particular category in any other time period, past, immediate past to present, or future. The table 440 integrated form of data for a CID is of course also useful when applying the predictive model for a category to a CID's (consumer's) purchase history data.

450 shows a table representing the target category correlation functions (TCCFs) in vector form. Data in a record in table 440 would be dot multiplied by values in a record in table 450, and then the resulting values summed, to provide a value of predictive analysis for the CID of the table 440's record for purchasing in the target category. The fields in table 450 are TCCFk (k= . . . m), which are the target category correlation functions for categories 1 . . . m, and correlation coefficients ak1 . . . akm. In the example discussed herein, each correlation coefficient ak1 to akm represents the correlation of purchase in non target category a . . . m to purchase in target category k.

460 shows a table representing the result of application of the TCCFs of table 450 to a consumer's integrated product purchase data of table 440. It's fields V(TCCF1) . . . C(TCCFn) are the values of the TCCFs applied to the consumer's integrated product purchase history and CID for the consumer. The TCCFs, when normalized, are the expected amounts of purchase by the consumer in each category.

470 shows a table representing the ratio of a consumer's actual category purchases KiCATi to the consumer's expected category purchases V(TCCFi) for i= . . . m. As previously mentioned, this data may be used to determine whether to offer an incentive to the consumer for purchase of a product i category item, and to determine the currency amount of any such incentive.

480 shows a table representing the rewards available for each category. It includes fields CAT for category name, Reward PID rule, and Reward amount. The Reward rule may specify conditions applicable to corresponding data in tables 460, 470 that must be satisfied for associating with the corresponding CID the Reward amount. Code implemented on the corresponding CS would retrieve and apply rules in table 480 to date in tables 460, 470, when determining what product purchase incentive offers data to associate with each CID.

The description of FIG. 4 is exemplary. For example, either or both of quantity and currency purchase value of products may be stored and used as the basis for the predictive analysis, and as is well known in the arts other formats may be used in a CS to represent the data shown in FIG. 4. However, this format provides a relatively simple description of data relationships and processing of the type useful in implementing the claimed inventions. For example, one rule might be, provide an incentive value of $1.00 to identified CIDs having no purchases in the target category, $0.50 for CIDs having less than 12 the expected quantity (number of items) or volume (currency amount) of purchases in the target category, and no incentive if the CID has greater than ½ of the expected quantity (number of items) or volume (currency amount) of purchases in the target category, and make the incentive contingent upon purchasing product X in the specified category.

It should be noted that retailers should find this invention appealing because it can increase the retailer's store sales. However, manufacturers may also find this program interesting because it provide them leverage in areas where one retail store carries their brands in the target category and competing retail stores do not carry their brands. Thus, a manufacturer could decide to offer incentives for purchase of that manufacturer's brand of product to CIDs having purchase records meeting the predictive modeling criteria noted herein, on the assumption that the manufacturer is losing that business to that customer in that target category to competing retailers.

Furthermore, CS 1 may prioritize incentive offers for a CID, some of which meeting the predictive modeling criteria discloses herein and some of which meet other targeted marketing criteria, in a manner that benefitted both the retailer and a particular manufacturer. For example, CS 1 could implement the predictive modeling targeted marketing herein for a target category for a retail store, and limit incentive offers to CIDs in that retail store only to those categories having a particular manufacturer's product as the requirement for obtaining the inventive value. Likewise, manufacturers could select, by retailer, which product categories they would authorize offering targeted incentive offers based upon predictive analysis. For example, manufacturers might favor sales of certain categories in one retail chain in a geographic area over another retail chain, for example based upon contractual price differences, and try to drive more sales in the favored retail chain's stores using predictive modeling to impact consumers store selections.

The invention is not limited to the specific example above. It is more properly defined by the scope of the following claims. The Attachments I-V below are described herein above.

We claim:

1. A computerized method for selecting consumers to which to provide purchase incentive offers for purchase of products, comprising:
(1) storing in computer memory purchase history data for purchases from one or more retail stores during a certain time period, wherein said purchase history data includes CID records, wherein each CID record stores in association with one another at least CID, PIDs of products purchased in transactions associated with said at least one CID, and quantity of product items having said PIDs;
(2) defining a Target Category Correlation Function (TCCF) for a target category, wherein said TCCF is a function of at least quantity of purchase of products in non target categories;
(3) applying statistical analysis to at least a subset of said purchase history records and said TCCF to define values of coefficients for terms of said TCCF, said values corresponding to correlation of purchase of products in non target categories to purchase of products in said target category;
(4) applying said TCCF to purchase history records associated with CIDs to obtain CID TCCF values for said CIDs;
(5) deciding whether to provide purchase incentive offers for purchase of products in said target category to consumers associated with said CIDs based at least in part upon said CID TCCF values.

2. The method of claim 1 wherein said (5) deciding is also based at least in part upon values for quantity or volume of purchase in said target category associated with said CIDs.

3. The method of claim 1 wherein said (1) storing also comprises storing in said CID records volume of product items having said PIDs.

4. The method of claim 1 wherein said (5) deciding further comprises:
determining from said CIDs target category offer CIDs (i) whose purchase history records have no purchases in said target category and (ii) that have relatively high TCCF values; and
associating with at least one of said target category offer CIDs purchase incentive offer data identifying at least one product in said target category.

5. The method of claim 1 wherein said TCCF is normalized so that its value defines an expected volume of purchase in said target category, wherein volume is a measure of at least one of number of product items purchased and currency value of product items purchased; and
further comprising determining a ratio of actual purchase volume in said target category to CID TCCF value for one of said CIDs.

6. The method of claim 1 wherein said purchase history data includes a plurality of CID records for a CID, wherein each one of said plurality of CID records storing data corresponding to a single transaction.

7. The method of claim 1 wherein said purchase history data includes a plurality of CID records for a CID including at least one record storing data from more than one transaction.

8. The method of claim 1 wherein said purchase history data includes a plurality of CID records for a certain CID, each of said plurality of CID records storing transaction data for transactions in a time period, such that different ones of said plurality of CID records store transaction data from different time periods.

9. The method of claim 1 wherein said TCCF has the form of a linear equation consisting of a sum of terms, wherein each term is a coefficient multiplied by a variable indicating product or category purchase volume.

10. The method of claim 1 wherein said coefficient is a measure of statistical correlation of purchase in a non target category to purchase in said target category.

11. The method of claim 1 wherein said TCCF has the form of a sum of terms Aij*Pj where Aij represents statistical correlation of purchase in an ith non target category to purchase in target category j, and Pj is a variable representing the volume of purchase in category j.

12. The method of claim 4 wherein said relatively high TCCF values including only values within the top 20 percent of all TCCF values.

13. The method of claim 5 wherein said determining a ratio comprises determining whether said ratio is less than a specified fraction which is less than one.

14. The method of claim 1 further comprising defining TCCFs for a plurality of categories, and performing (3) to (5) for each one of those TCCFs.

15. The method of claim 14 wherein at least one of said purchase incentive offers defined a plurality of products, each one of said plurality of products in a different category, and said purchase incentive offer required a consumer to purchase each one of said plurality of products in order to receive an incentive associated with said at least one of said purchase incentive offers.

16. The method of claim 1 further comprising transmitting said purchase history data to a central CS and wherein steps (1) occurs at said central CS.

17. The method of claim 1 wherein steps (3) and (4) occur at said central CS.

18. The method of claim 1 further comprising transmitting a subset of said CIDs and associated product purchase incentive offers for said target category from a central CS to a POS CS from which transaction data containing CIDs in said subset had been transmitted to said central CS.

19. The method of claim 1 further comprising associating all CIDs records associated with the same residence address with a single CID.

20. The method of claim 1 further comprising limiting determining said subset of said purchase history records by selecting from said purchase history records only those records in which block data and retail store customer data from a retail store indicate that all purchasers from the same residence address purchase in said retail store.

21. A computer system for selecting consumers to which to provide purchase incentive offers for purchase of products, comprising:
at least one central processing unit;
an input device;
an output device;
(1) computer memory storing purchase history data for purchases from one or more retail stores during a certain time period, wherein said purchase history data includes CID records, wherein each CID record stores in association with one another at least CID, PIDs of products purchased in transactions associated with said at least one CID, and quantity of product items having said PIDs;
(2) code stored in computer memory defining a Target Category Correlation Function (TCCF) for a target category, wherein said TCCF is a function of at least quantity of purchase of products in non target categories;
(3) code stored in computer memory for applying statistical analysis to at least a subset of said purchase history records and said TCCF to define values of coefficients for terms of said TCCF, said values corresponding to correlation of purchase of products in non target categories to purchase of products in said target category;
(4) code stored in computer memory for applying said TCCF to purchase history records associated with CIDs to obtain CID TCCF values for said CIDs;
(5) code stored in computer memory for deciding whether to provide purchase incentive offers for purchase of products in said target category to consumers associated with said CIDs based at least in part upon said CID TCCF values.

22. The system of claim 21 wherein element (1) is stored in a central CS and element (2) is not stored on said central CS.

23. The system of claim 21 wherein elements (1), (4), and (5) are stored in a central CS.
